(19) United States
(12) Patent Application Publication
(10) Pub. No.: US 2023/0276464 A1
(43) Pub. Date: Aug. 31, 2023

(54) METHODS AND APPARATUSES FOR A SIDELINK RESOURCE RE-EVALUATION PROCEDURE

(71) Applicant: LENOVO (BEIJING) LIMITED, BEIJING (CN)

(72) Inventors: XIAODONG YU, BEIJING (CN); ZHENNIAN SUN, BEIJING (CN); HAIPENG LEI, BEIJING (CN); XIN GUO, BEIJING (CN)

(21) Appl. No.: 18/040,652

(22) PCT Filed: Aug. 5, 2020
(86) PCT No.: PCT/CN2020/107081

§ 371 Date: Feb. 6, 2023

(51) Int. Cl. H04W 72/25

(52) U.S. Cl. CPC H04W 72/25

(57) ABSTRACT

Embodiments of the present disclosure relate to methods and apparatuses for a sidelink resource re-evaluation procedure under 3GPP (3rd Generation Partnership Project) 5G new radio (NR). According to an embodiment of the present disclosure, a method includes: receiving resource indication information, wherein the resource indication information indicates one or more sidelink resources; determining a resource re-evaluation window in time domain; performing, during the resource re-evaluation window, a re-evaluation procedure for the one or more sidelink resources; and in response to a sidelink resource within the one or more sidelink resources being available, transmitting a sidelink transmission on the sidelink resource.

### TECHNICAL FIELD

Embodiments of the present application are related to wireless communication technology, and more particularly, related to methods and apparatuses for a sidelink resource re-evaluation procedure under 3GPP (3rd Generation Partnership Project) 5G new radio (NR).

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP (3rd Generation Partnership Project) Release 12, and enables a direct communication between proximal UEs, and data does not need to go through a base station (BS) or a core network.

3GPP 5G and/or new radio (NR) networks are expected to increase network throughput, coverage, and robustness and reduce latency and power consumption. With the development of 5G and NR networks, various aspects need to be studied and developed to perfect the 5G and/or NR technology.

### SUMMARY

Some embodiments of the present application provide a method, which may be performed by a user equipment (UE), e.g., a sidelink reception UE. The method includes: receiving resource indication information, wherein the resource indication information indicates one or more sidelink resources; determining a resource re-evaluation window in time domain; performing, during the resource re-evaluation window, a re-evaluation procedure for the one or more sidelink resources; and in response to a sidelink resource within the one or more sidelink resources being available, transmitting a sidelink transmission on the sidelink resource.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a reception UE.

Some embodiments of the present application provide a method which may be performed by a UE, e.g., a sidelink transmission UE. The method includes: performing a sensing procedure and a resource selection procedure, to select one or more sidelink resources; generating resource indication information, wherein the resource indication information indicates the one or more sidelink resources; and transmitting the resource indication information.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a transmission UE.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1 illustrates an exemplary V2X communication system in accordance with some embodiments of the present application;

FIG. 2 illustrates an exemplary diagram of a resource reservation mechanism for a transport block (TB) according to some embodiments of the present application;

FIG. 3 illustrates a further exemplary diagram of a resource reservation mechanism for a TB according to some embodiments of the present application;

FIG. 4 illustrates a flow chart of a method for determining a resource re-evaluation window according to some embodiments of the present application;

FIG. 5 illustrates an exemplary diagram of a sidelink resource re-evaluation procedure according to some embodiments of the present application;

FIG. 6 illustrates a flow chart of a method for generating resource indication information according to some embodiments of the present application; and

FIG. 7 illustrates an exemplary block diagram of an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8, B5G, 6G, and so on. It is contemplated that along with developments of network architectures and new service scenarios, all embodiments in the present application are also applicable to similar technical problems; and moreover, the terminologies recited in the present application may change, which should not affect the principle of the present application.

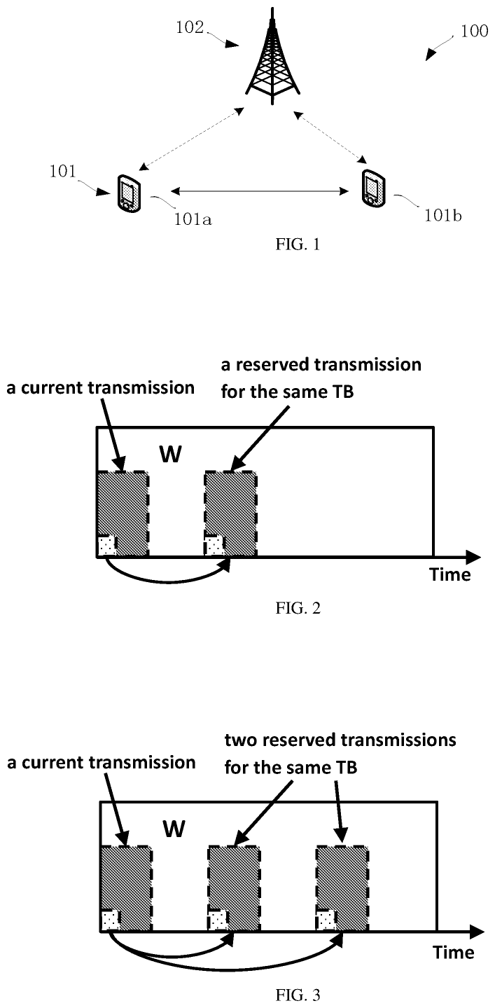

FIG. 1 illustrates an exemplary V2X communication system in accordance with some embodiments of the present application.

As shown in FIG. 1, a wireless communication system 100 includes at least one user equipment (UE) 101 and at least one base station (BS) 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present application, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

In some embodiments of the present application, a UE is a pedestrian UE (P-UE or PUE) or a cyclist UE. In some embodiments of the present application, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate directly with BSs 102 via LTE or NR Uu interface.

In some embodiments of the present application, each of the UE(s) 101 may be deployed an IoT application, an eMBB application and/or a URLLC application. For instance, UE 101a may implement an IoT application and may be named as an IoT UE, while UE 101b may implement an eMBB application and/or a URLLC application and may be named as an eMBB UE, an URLLC UE, or an eMBB/URLLC UE. It is contemplated that the specific type of application(s) deployed in the UE(s) 101 may be varied and not limited.

In a V2X communication system, a transmission UE may also be named as a transmitting UE, a Tx UE, a sidelink Tx UE, a sidelink transmission UE, or the like. A reception UE may also be named as a receiving UE, a Rx UE, a sidelink Rx UE, a sidelink reception UE, or the like.

According to some embodiments of FIG. 1, UE 101a functions as a Tx UE, and UE 101b functions as a Rx UE. UE 101a may exchange V2X messages with UE 101b through a sidelink, for example, PC5 interface as defined in 3GPP TS 23.303.

UE 101a may transmit information or data to other UE(s) within the V2X communication system, through sidelink unicast, sidelink groupcast, or sidelink broadcast. For instance, UE 101a transmits data to UE 101b in a sidelink unicast session. UE 101a may transmit data to UE 101b and other UEs in a groupcast group (not shown in FIG. 1) by a sidelink groupcast transmission session. Also, UE 101a may transmit data to UE 101b and other UEs (not shown in FIG. 1) by a sidelink broadcast transmission session.

Alternatively, according to some other embodiments of FIG. 1, UE 101b functions as a Tx UE and transmits V2X messages, UE 101a functions as a Rx UE and receives the V2X messages from UE 101b.

Both UE 101a and UE 101b in the embodiments of FIG. 1 may transmit information to BS(s) 102 and receive control information from BS(s) 102, for example, via LTE or NR Uu interface. The BS(s) 102 may be distributed over a geographic region. In certain embodiments of the present application, each of the BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. The BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein the BS(s) 102 transmit data using an OFDM modulation scheme on the downlink (DL) and the UE(s) 101 transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, the BS(s) 102 may communicate using other communication protocols, such as the IEEE 802.11 family of wireless communication protocols. Further, in some embodiments of the present application, the BS(s) 102 may communicate over licensed spectrums, whereas in other embodiments, the BS(s) 102 may communicate over unlicensed spectrums. The present application is not intended to be limited to the implementation of any particular wireless communication system architecture or protocol. In yet some embodiments of present application, the BS(s) 102 may communicate with the UE(s) 101 using the 3GPP 5G protocols.

The UE(s) 101 may access the BS(s) 102 to receive data packets from the BS(s) 102 via a downlink channel and/or transmit data packets to the BS(s) 102 via an uplink channel. In normal operation, since the UE(s) 101 does not know when the BS(s) 102 will transmit data packets to it, the UE(s) 101 has to be awake all the time to monitor the downlink channel (e.g., a Physical Downlink Control Channel (PDCCH)) to get ready for receiving data packets from the BS(s) 102. However, if the UE(s) 101 keeps monitoring the downlink channel all the time even when there is no traffic between the BS(s) 102 and the UE(s) 101, it would result in significant power waste, which is problematic to a power limited or power sensitive UE.

Currently, an agreement in a 3GPP 5G system or the like is that a resource selection procedure and a resource re-evaluation procedure are performed by the same UE. After the resource selection procedure, a UE will perform a resource re-evaluation procedure for the selected resource(s). If the selected resource(s) is usable, the UE will perform sidelink transmission(s) on the selected resource(s).

Under the abovementioned agreement, the UE shall indicate frequency and time resource(s) in sidelink control information (SCI) for the current transmission and potential subsequent transmission(s). The total number of the frequency and time resource(s) may be configured by a higher layer of the UE. For instance, a higher layer of the UE configures that there are two transmission resource(s) indicated in SCI including the current transmission, or configures that there are three transmission resource(s) indicated in SCI including the current transmission. Specific examples are described in FIGS. 2 and 3.

FIG. 2 illustrates an exemplary diagram of a resource reservation mechanism for a transport block (TB) according to some embodiments of the present application.

As shown in FIG. 2, a window in time domain is marked as “W” and includes two transmission resources for a TB. In an example, the window W is of 32 slots in the time domain. Specifically, the window W includes a current transmission of a TB and one reserved re-transmission for the same TB. The current transmission of the TB includes SCI, which is an area in the current transmission marked with tiny black dots as shown in FIG. 2. The SCI of the current transmission indicates one resource reserved for the reserved re-transmission in the window W.

FIG. 3 illustrates a further exemplary diagram of a resource reservation mechanism for a TB according to some embodiments of the present application. The embodiments of FIG. 3 are similar to the embodiments of FIG. 2.

As shown in FIG. 3, a window in time domain is marked as “W” and includes three transmission resources for a TB. In an example, the window W is of 32 slots in the time domain. Specifically, the window W includes a current transmission of a TB and two reserved re-transmissions for the same TB. The current transmission of the TB includes SCI, which is an area in the current transmission marked with tiny black dots as shown in FIG. 3. The SCI of the current transmission indicates two resources reserved for these two reserved re-transmissions in the window W.

As mentioned above, in the agreement regarding a resource selection and resource re-evaluation mechanism, a UE who performs a resource selection procedure for its own sidelink transmission should also perform a resource re-evaluation procedure before transmitting its sidelink transmission on the selected resource. Considering the power consumption of a power sensitive UE (e.g., a P-UE), the UE may perform a partial sensing procedure or a random selection procedure in its transmission pool. However, in such scenarios, a potential collision probability will be increased, especially, a collision probability with an aperiodic transmission in 5G NR V2X. Thus, there is a need to provide solutions to save a UE's power consumption during performing a sensing procedure or a random selection procedure and to avoid a transmission collision from a V2X communication system's perspective.

Embodiments of the present application consider the power consumption of a power sensitive UE, define a re-evolution window at the UE side based on a resource selected by another UE, and will be specifically described below.

In some embodiments of the present application, a short resource re-evaluation window replaces a long-term sensing procedure at a UE side, and a sidelink transmission on an indicated resource can avoid a potential collision with an aperiodic traffic. These embodiments have much benefit not only for saving the UE's power consumption but also for avoiding a transmission collision from a system's perspective.

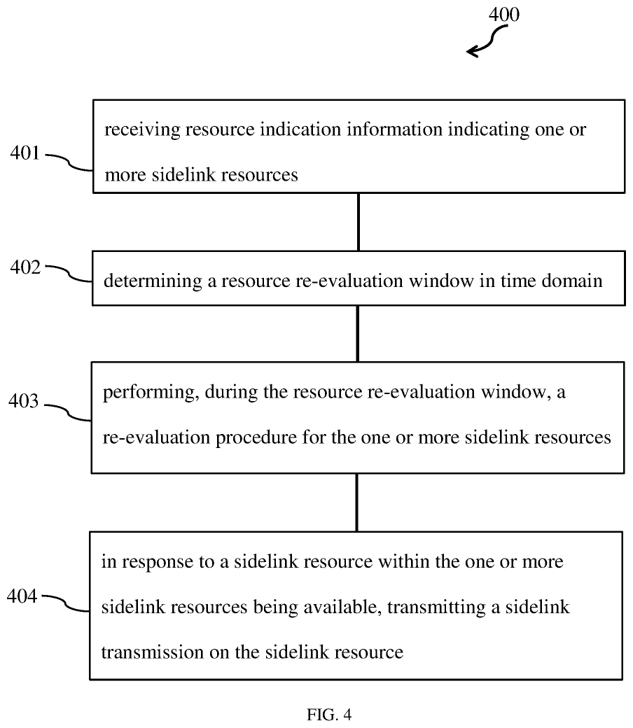

FIG. 4 illustrates a flow chart of a method for determining a resource re-evaluation window according to some embodiments of the present application. The embodiments of FIG. 4 may be performed by a UE or a Rx UE (e.g., UE 101a or UE 101b illustrated and shown in FIG. 1). Although described with respect to a UE, it should be understood that other devices may be configured to perform a method similar to that of FIG. 4.

In the exemplary method 400 as shown in FIG. 4, in operation 401, a UE (e.g., UE 101a illustrated and shown in FIG. 1) receives resource indication information. The resource indication information indicates one or more sidelink resources. The one or more sidelink resources may also be named as “the indicated reserved resource(s)”. In an example, the UE receives the resource indication information from another UE (e.g., UE 101b illustrated and shown in FIG. 1). The resource indication information may be generated after the abovementioned another UE performing a sensing procedure and a resource selection procedure.

According to some embodiments, the resource indication information is included in SCI. In an embodiment, the resource indication information is included in a first stage of the SCI transmitted on a physical sidelink control channel (PSCCH). In a further embodiment, the resource indication information is included in a second stage of the SCI transmitted on a physical sidelink shared channel (PSSCH). Two stages of SCI are defined in 3GPP standard documents of NR V2X Release 16. In particular, the first stage of SCI is used to indicate its associated second stage of SCI and data transmission. The first stage of SCI is mapped on PSCCH. The second stage of SCI is mapped on PSSCH with the data transmission.

In an embodiment, the UE transmits a resource request for a sidelink transmission, and the resource indication information received in operation 401 is generated based on the resource request. In an example, the UE transmits the resource request to another UE (e.g., UE 101b illustrated and shown in FIG. 1), who performs a sensing procedure and a resource selection procedure and then generates the resource indication information.

In an example, the resource request is transmitted on a resource in a resource pool. The resource pool may be pre-configured or configured by a network or a BS. For instance, the UE (i.e., UE 101a illustrated and shown in FIG. 1) receives configuration information regarding a (pre-)configured resource pool from another UE, and then transmits a resource request on a resource in the (pre-)configured resource pool according to the configuration information.

In an example, the resource request is transmitted on a resource selected by the UE through a resource random selection procedure. The UE may select a resource by a resource random selection procedure in time and frequency domains and transmit a resource request on the selected resource. In particular, the UE (e.g., UE 101a illustrated and shown in FIG. 1) may select a resource in a (pre-)configured resource pool by a resource random selection procedure and transmit a resource request on the selected resource.

Referring back to FIG. 4, in operation 402, the UE determines a resource re-evaluation window in time domain. In operation 403, the UE performs, during the resource re-evaluation window, a re-evaluation procedure for the indicated reserved resource(s), i.e., the one or more sidelink resources that are indicated by the resource indication information received in operation 401. In operation 404, if a sidelink resource within the indicated reserved resource(s) is re-evaluated as available or usable, the UE transmits a sidelink transmission on the sidelink resource.

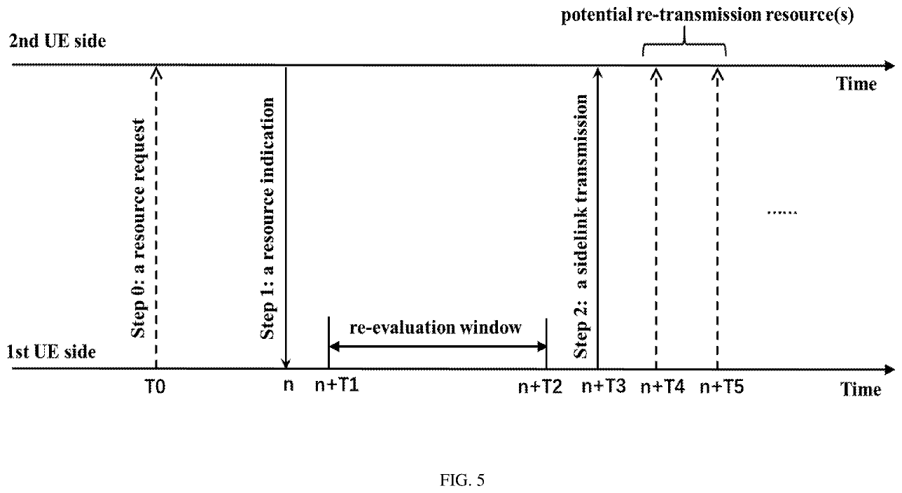

According to some embodiments, “a starting boundary in the time domain of the resource re-evaluation window” (e.g., “n+T1” illustrated and shown in FIG. 5) is later than “a time instance of receiving the resource indication information” (e.g., “n” illustrated and shown in FIG. 5). “An ending boundary in the time domain of the resource re-evaluation window” (e.g., “n+T2” illustrated and shown in FIG. 5) is earlier than “a time instance of an earliest sidelink resource within the indicated reserved resource(s)” (e.g., “n+T3” illustrated and shown in FIG. 5).

In an embodiment, a time gap (e.g., “T1” illustrated and shown in FIG. 5) between “a time instance of receiving the resource indication information” and “a starting boundary in the time domain of the resource re-evaluation window” is associated with processing time of the UE (e.g., UE 101a illustrated and shown in FIG. 1).

In a further embodiment, a time gap (e.g., a difference between “T3” and “T2” illustrated and shown in FIG. 5, i.e., “T3−T2”) between “an ending boundary in the time domain of the resource re-evaluation window” and “a time instance of an earliest sidelink resource within the indicated reserved resource(s)” is associated with the processing time of the UE.

In an additional embodiment, a time gap (e.g., “T3” illustrated and shown in FIG. 5) between “a time instance of receiving the resource indication information” and “a time instance of an earliest sidelink resource within the indicated reserved resource(s)” is associated with a capability of the UE (e.g., UE 101a illustrated and shown in FIG. 1).

In another embodiment, a time gap (e.g., “T3” illustrated and shown in FIG. 5) between “a time instance of receiving the resource indication information” and “a time instance of an earliest sidelink resource within the indicated reserved resource(s)” is associated with resource pool configuration information. For instance, the resource pool configuration information includes a field to indicate a minimum value of the time gap (e.g., “T3” illustrated and shown in FIG. 5).

According to some embodiments, the UE receives SCI which includes a field. The field represents whether the indicated reserved resource(s), which is indicated by the resource indication information received in operation 401, is used for transmitting a sidelink transmission or receiving a sidelink transmission. The field may be transmitted in the first stage of SCI or in the second stage of SCI. The field may include one or more bits.

In one example, the field includes 1 bit. A value ‘1’ of the bit represents that the indicated reserved resource(s) is used for transmitting the UE's sidelink transmission, and a value ‘0’ of the bit represents that the indicated reserved resource(s) is used for receiving another UE's sidelink transmission, and vice versa. That is, the value ‘1’ of the bit represents that the UE may transmit a sidelink transmission on the indicated reserved resource(s), and the value ‘0’ of the bit represents that the UE may receive a sidelink transmission on the indicated reserved resource(s), and vice versa.

In a further example, a field includes two or more bits. The field may be a bit map. Each bit of the bit map corresponds to one resource within the indicated reserved resource(s) and indicates whether the resource is used for transmitting a sidelink transmission or receiving a sidelink transmission.

In the embodiments of FIG. 4, another UE (e.g., UE 101b illustrated and shown in FIG. 1) helps the UE which is power-sensitive (e.g., UE 101a illustrated and shown in FIG. 1) to perform a sensing procedure and a resource selection procedure. In other words, a resource selection procedure and a resource re-evaluation procedure are performed at different UE sides. Moreover, in the embodiments of FIG. 4, boundaries of the resource re-evaluation window in time domain are defined based on a transmission time instance at the UE which is power-sensitive, and a usage of the resource re-evaluation window may avoid a transmission collision from a system's perspective.

Details described in the embodiments as illustrated and shown in FIGS. 1-3 and 5-7, especially, contents related to defining a resource re-evaluation window, are applicable for the embodiments as illustrated and shown in FIG. 4. Moreover, details described in the embodiments of FIG. 4 are applicable for all the embodiments of FIGS. 1-3 and 5-7.

FIG. 5 illustrates an exemplary diagram of a sidelink resource re-evaluation procedure according to some embodiments of the present application. FIG. 5 shows a sidelink resource re-evaluation procedure in time domain between two UEs, i.e., 1st UE side and 2nd UE side as shown in FIG. 5. The 1st UE may be UE 101a or UE 101b illustrated and shown in FIG. 1. The 2nd UE may be UE 101b or UE 101a illustrated and shown in FIG. 1. The embodiments of FIG. 5 assume that the 1st UE is a power sensitive UE, e.g., a P-UE.

According to the embodiments of FIG. 5, in step 0, the 1st UE (e.g., UE 101a illustrated and shown in FIG. 1) transmits a resource request to the 2nd UE (e.g., UE 101b illustrated and shown in FIG. 1) at time instance “T0” in time domain as shown in FIG. 5. The 2nd UE performs a sensing procedure and a resource selection procedure and generates a resource indication. In step 1, the 2nd UE sends the resource indication at time instance “n” in time domain as shown in FIG. 5, to indicate selected one or more sidelink transmission resource(s) for the 1st UE.

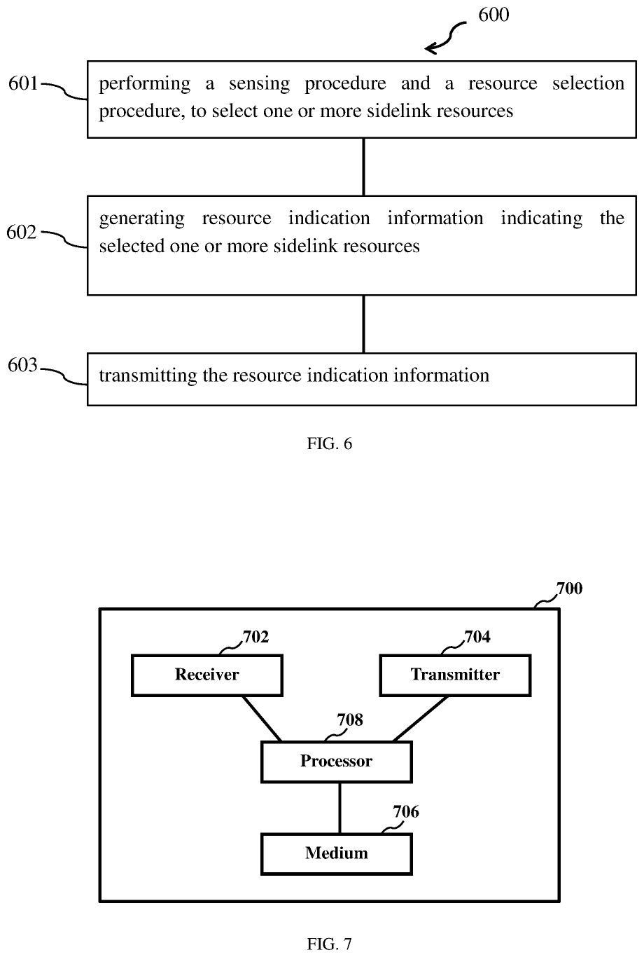

The resource indication may be carried in SCI and data associated with the SCI. In particular, the resource indication may be carried in the first stage of SCI transmitted on PSCCH (i.e., a control channel) or in the second stage of SCI transmitted on PSSCH (i.e., a data channel). The resource indication may also be named as resource indication information. The resource indication in the embodiments of FIG. 5 corresponds to the resource indication information in the embodiments of FIGS. 4 and 6.

The step 0 is optional. In one case, after receiving the resource request from the 1st UE, the 2nd UE generates a resource indication based on the received resource request and sends the resource indication. In another case, the 2nd UE generates a resource indication and sends the resource indication, but not based on any resource request.

In an embodiment, the resource request is transmitted in a (pre-)configured resource pool, which may be pre-configured or configured by a network or a BS. For instance, the 1st UE performs a resource random selection procedure in the (pre-)configured resource pool, to select a resource for transmitting the resource request.

In a further example, the resource request is transmitted on a resource selected by the 1st UE based on a resource random selection procedure in the time and frequency domains.

In an embodiment, the resource indication only indicates one sidelink transmission resource, e.g., a resource allocated at time instance “n+T3” in time domain as shown in FIG. 5, but does not indicate any potential re-transmission resource.

In a further embodiment, the resource indication indicates two sidelink transmission resources. The earliest resource is allocated at time instance “n+T3” in time domain as shown in FIG. 5. A potential re-transmission resource is allocated at time instance “n+T4” in time domain as shown in FIG. 5.

In another embodiment, the resource indication indicates three sidelink transmission resources. The earliest resource is allocated at time instance “n+T3” in time domain as shown in FIG. 5. Two potential re-transmission resources are allocated at time instances “n+T4” and “n+T5” in time domain as shown in FIG. 5, respectively.

Although a specific number of potential re-transmission resources are depicted in FIG. 5, it is contemplated that, in different embodiments, there may be more or less potential re-transmission resources within the indicated reserved resource(s) that are indicated by the resource indication.

Based on the received resource indication, the 1st UE may determine a resource re-evaluation window and perform a resource re-evaluation procedure during the resource re-evaluation window. In the embodiments of FIG. 5, the resource re-evaluation window starts from time instance “n+T1” and ends at time instance “n+T2” in time domain as shown in FIG. 5.

After performing the resource re-evaluation procedure, for example, if the 1st UE determines that the indicated resource at time instance “n+T3” can be used for a sidelink transmission, i.e., the 1st UE determines that the earliest indicated resource is available or usable, the 1st UE may transmit a sidelink transmission on this usable resource.

“T1” may depend upon processing time of the 1st UE. For example, the processing time of the 1st UE includes the 1st UE's time of receiving and decoding the resource indication.

In the time domain, time instance “n+T2” is earlier than time instance “n+T3”. That is, the value of “T2” is less than the value of “T3”. In an example, “T2” is equal to or less than “T3-t_proc”, wherein “t_proc” represents the processing time of the 1st UE (e.g., P-UE). For instance, “t_proc” includes at least one of:
The 1st UE's time of re-evaluating one or more sidelink transmission resources (which are indicated by the 2nd UE) during a resource re-evaluation procedure.
The 1st UE's time of switching from a reception status to a transmission status. In the reception status, the 1st UE may receive a sidelink transmission. In the transmission status, the 1st UE may transmit a sidelink transmission.

When performing a resource selection procedure, the 2nd UE should ensure that a time gap (e.g., “T3” illustrated and shown in FIG. 5) between “a time instance of transmitting the a resource indication” (e.g., “n” illustrated and shown in FIG. 5) and “the earliest indicated reserved resource in time domain” (e.g., “n+T3” illustrated and shown in FIG. 5) is greater than a pre-defined time value. In other words, the time gap “T3” needs to meet the transmission timing.

“T3” can depend on the 1st UE's capability or based on resource pool configuration information that is configured for the 1st UE. In an example, the resource pool configuration information includes a field to indicate a minimum value of “T3”. Thus, during the resource selection procedure, if the 2nd UE selects resource(s), e.g., based on a resource request from the 1st UE, the time gap “T3” should be greater than a pre-defined minimum time value.

Details described in the embodiments as illustrated and shown in FIGS. 1-4, 6, and 7, especially, contents related to defining a resource re-evaluation window, are applicable for the embodiments as illustrated and shown in FIG. 5. Moreover, details described in the embodiments of FIG. 5 are applicable for all the embodiments of FIGS. 1-4, 6, and 7.

FIG. 6 illustrates a flow chart of a method for generating resource indication information according to some embodiments of the present application. The embodiments of FIG. 6 may be performed by a UE or a Tx UE (e.g., UE 101a or UE 101b illustrated and shown in FIG. 1). Although described with respect to a UE, it should be understood that other devices may be configured to perform a method similar to that of FIG. 6.

In the exemplary method 600 as shown in FIG. 6, in operation 601, a UE (e.g., UE 101b illustrated and shown in FIG. 1) performs a sensing procedure and a resource selection procedure, to select one or more sidelink resources. In operation 602, the UE generates resource indication information, to indicate the selected one or more sidelink resources.

In operation 603, the UE transmits the generated resource indication information. In an example, the UE transmits SCI which includes the generated resource indication information. The resource indication information may be included in a first stage of the SCI transmitted on PSCCH. Alternatively, the resource indication information may be included in a second stage of the SCI transmitted on PSSCH.

In some embodiments, the UE receives a resource request for a sidelink transmission, and generates the resource indication information based on the received resource request. In an example, the resource request is received on a resource in a resource pool that is pre-configured or configured by a network or a BS. In a further example, the resource request is received on a resource selected by a resource random selection procedure in the time and frequency domains.

For instance, with reference to the embodiments of FIG. 1, UE 101a transmits a resource request for a sidelink transmission to UE 101b. Based on the resource request, UE 101b performs a sensing procedure and a resource selection procedure, to select one or more sidelink resources. Then, UE 101b generates resource indication information, which indicates the one or more sidelink resources, and transmits the resource indication information to UE 101a.

In some embodiments, if a sidelink resource within the one or more sidelink resources is available, the UE (e.g., UE 101b illustrated and shown in FIG. 1) receives a sidelink transmission on the sidelink resource. For instance, if a sidelink resource within the one or more sidelink resources is re-evaluated by UE 101a as available or usable, UE 101a may transmit a sidelink transmission on the sidelink resource, and UE 101b may receive the sidelink transmission on the sidelink resource from UE 101a.

According to some embodiments, the UE (e.g., UE 101b illustrated and shown in FIG. 1) transmits SCI. In an example, the SCI may include a field including one or more bits. The field represents whether the one or more sidelink resources are used for transmitting a sidelink transmission or receiving a sidelink transmission.

According to some embodiments, a time gap (e.g., “T3” illustrated and shown in FIG. 5) between “a time instance of the UE (e.g., UE 101b illustrated and shown in FIG. 1) transmitting the resource indication information” and “a time instance of an earliest sidelink resource within the one or more sidelink resources” is associated with a capability of a UE (e.g., UE 101a illustrated and shown in FIG. 1) who receives the resource indication information.

According to some other embodiments, the time gap (e.g., “T3” illustrated and shown in FIG. 5) is associated with resource pool configuration information of a UE (e.g., UE 101a illustrated and shown in FIG. 1) who receives the resource indication information. For example, the resource pool configuration information includes a field, to indicate a minimum value of the time gap.

Details described in the embodiments as illustrated and shown in FIGS. 1-5 and 7, especially, contents related to defining a resource re-evaluation window, are applicable for the embodiments as illustrated and shown in FIG. 6. Moreover, details described in the embodiments of FIG. 6 are applicable for all the embodiments of FIGS. 1-5 and 7.

FIG. 7 illustrates an exemplary block diagram of an apparatus according to some embodiments of the present application. In some embodiments of the present application, the apparatus 700 may be a UE (e.g., a Rx UE), which can at least perform the method illustrated in FIG. 4. In some embodiments of the present application, the apparatus 700 may be a UE (e.g., a Tx UE), which can at least perform the method illustrated in FIG. 6.

As shown in FIG. 7, the apparatus 700 may include at least one receiver 702, at least one transmitter 704, at least one non-transitory computer-readable medium 706, and at least one processor 708 coupled to the at least one receiver 702, the at least one transmitter 704, and the at least one non-transitory computer-readable medium 706.

Although in FIG. 7, elements such as the at least one receiver 702, the at least one transmitter 704, the at least one non-transitory computer-readable medium 706, and the at least one processor 708 are described in the singular, the plural is contemplated unless limitation to the singular is explicitly stated. In some embodiments of the present application, the at least one receiver 702 and the at least one transmitter 704 are combined into a single device, such as a transceiver. In certain embodiments of the present application, the apparatus 700 may further include an input device, a memory, and/or other components.

In some embodiments of the present application, the at least one non-transitory computer-readable medium 706 may have stored thereon computer-executable instructions which are programmed to implement the operations of the methods, for example as described in view of FIG. 4 or FIG. 6, with the at least one receiver 702, the at least one transmitter 704, and the at least one processor 708.

Those having ordinary skills in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

1. A method, comprising:
receiving resource indication information indicating one or more sidelink resources;
determining a resource re-evaluation window in time domain;
performing, during the resource re-evaluation window, a re-evaluation procedure for the one or more sidelink resources; and
in response to a sidelink resource within the one or more sidelink resources being available, transmitting a sidelink transmission on the sidelink resource.

2. The method of claim 1, further comprising:
transmitting a resource request for a sidelink transmission, wherein the resource indication information is generated based on the resource request.

3. The method of claim 2, wherein the resource indication information is generated after performing a sensing procedure and a resource selection procedure.

4. (canceled)

5. (canceled)

6. The method of claim 1, further comprising:
receiving sidelink control information (SCI), wherein the SCI includes a field including one or more bits, and the field represents whether the one or more sidelink resources are used for transmitting a sidelink transmission or receiving a sidelink transmission.

7. The method of claim 1, wherein the resource indication information is included in one of a first stage or a second stage of a sidelink control information (SCI) transmitted on a physical sidelink control channel (PSCCH).

8. (canceled)

9. (canceled)

10. The method of claim 1, wherein a starting boundary in the time domain of the resource re-evaluation window is later than a time instance of receiving the resource indication information, and an ending boundary in the time domain of the resource re-evaluation window is earlier than a time instance of an earliest sidelink resource within the one or more sidelink resources.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. An apparatus, comprising:
a non-transitory computer-readable medium having stored thereon computer-executable instructions;
a receiving circuitry;
a transmitting circuitry; and
a processor coupled to the non-transitory computer-readable medium, the receiving circuitry and the transmitting circuitry,
wherein the computer-executable instructions cause the processor to:
receive resource indication information indicating one or more sidelink resources;
determine a resource re-evaluation window in time domain;
perform, during the resource re-evaluation window, a re-evaluation procedure for the one or more sidelink resources; and
in response to a sidelink resource within the one or more sidelink resources being available, transmit a sidelink transmission on the sidelink resource.

29. (canceled)

30. The apparatus of claim 28, wherein the computer-executable instructions cause the processor to:
transmit a resource request for a sidelink transmission, wherein the resource indication information is generated based on the resource request.

31. The apparatus of claim 30, wherein the resource indication information is generated after performing a sensing procedure and a resource selection procedure.

32. The apparatus of claim 28, wherein the computer-executable instructions cause the processor to:
receive sidelink control information (SCI), wherein the SCI includes a field including one or more bits, and the field represents whether the one or more sidelink resources are used for transmitting a sidelink transmission or receiving a sidelink transmission.

33. The apparatus of claim 28, wherein the resource indication information is included in one of a first stage or a second stage of a sidelink control information (SCI) transmitted on a physical sidelink control channel (PSCCH).

34. The apparatus of claim 28, wherein a starting boundary in the time domain of the resource re-evaluation window is later than a time instance of receiving the resource indication information, and an ending boundary in the time domain of the resource re-evaluation window is earlier than a time instance of an earliest sidelink resource within the one or more sidelink resources.

35. An apparatus comprising:
a non-transitory computer-readable medium having stored thereon computer-executable instructions;
a receiving circuitry;
a transmitting circuitry; and
a processor coupled to the non-transitory computer-readable medium, the receiving circuitry and the transmitting circuitry, wherein the computer-executable instructions cause the processor to:
perform a sensing procedure and a resource selection procedure, to select one or more sidelink resources;
generate resource indication information that indicates the one or more sidelink resources; and
transmit the resource indication information.

36. The apparatus of claim 35, wherein the computer-executable instructions cause the processor to:
in response to a sidelink resource within the one or more sidelink resources being available, receiving a sidelink transmission on the sidelink resource.

37. The apparatus of claim 35, wherein the computer-executable instructions cause the processor to:
receive a resource request for a sidelink transmission, wherein the resource indication information is generated based on the resource request.

38. The apparatus of claim 37, wherein the resource request is received on a resource in a resource pool, and the resource pool is pre-configured or configured by a network or a base station (BS).

39. The apparatus of claim 35, wherein the computer-executable instructions cause the processor to:
transmit sidelink control information (SCI), wherein the SCI includes a field including one or more bits, and the field represents whether the one or more sidelink resources are used for transmitting a sidelink transmission or receiving a sidelink transmission.

40. The apparatus of claim 35, wherein the resource indication information is included in one of a first state and a second stage of a sidelink control information (SCI) and the transmitting the resource indication information comprises transmitting the SCI on a physical sidelink control channel (PSCCH).

41. The apparatus of claim 35, wherein a time gap between a time instance of transmitting the resource indication information and a time instance of an earliest sidelink resource within the one or more sidelink resources is associated with resource pool configuration information.

42. The apparatus of claim 41, wherein the resource pool configuration information includes a field, and the field indicates a minimum value of the time gap between the time instance of transmitting the resource indication information and the time instance of the earliest sidelink resource within the one or more sidelink resources.
